(19) United States
(12) Patent Application Publication
(10) Pub. No.: US 2024/0404773 A1
(43) Pub. Date: Dec. 5, 2024

(54) High voltage circuit breaker with particle trap

(71) Applicant: Hitachi Energy Ltd, Zürich (CH)

(72) Inventor: Christoph Wirth, Pfungen (CH)

(21) Appl. No.: 18/677,175

(22) Filed: May 29, 2024

(30) Foreign Application Priority Data
May 30, 2023 (EP) 23176105.7

(51) Int. Cl. H01H 33/30; H01H 33/14; H01H 33/24

(52) U.S. Cl. CPC H01H 33/302; H01H 33/14; H01H 33/24

(57) ABSTRACT

A high-voltage circuit breaker comprises a first main contact and a second main contact extending along a central longitudinal axis and being at least partially enclosed by an insulator, wherein the insulator has an inner surface facing the central longitudinal axis and being arranged at a first distance from the central longitudinal axis, and further comprises at least one particle trap for trapping particles generated during operation of the circuit breaker, wherein the particle trap has an inner surface facing the central longitudinal axis and being arranged at a second distance from the central longitudinal axis, the second distance being larger than the first distance.

### CROSS REFERENCE TO RELATED APPLICATION

This application claims priority to European Patent Application Number 23176105.7, filed on May 30, 2023, the disclosure and content of which is incorporated by reference herein in its entirety.

### FIELD

The present disclosure relates to a high-voltage circuit breaker. The circuit breaker may be part of a gas-insulated switchgear, for example.

### BACKGROUND

During mechanical switching and occurrence of power shots, particles may be generated in the circuit breaker. As an example, the particles may be metal particles generated from mechanical interaction of movable parts. Furthermore, dust may accumulate in the circuit breaker. Such particles and dust may accumulate on an insulator surface and may lead to deterioration or even bridging of an insulation gap.

### SUMMARY

Embodiments of the disclosure relate to an improved high-voltage circuit breaker.

According to a first aspect, a high-voltage circuit breaker comprises a first main contact and a second main contact extending along a central longitudinal axis and comprises an insulator at least partially enclosing the contacts. The insulator has an inner surface facing the central longitudinal axis, the inner surface being arranged at a first distance from the central longitudinal axis. The insulator may have a tubular shape, for example. The circuit breaker comprises at least one particle trap for trapping particles generated during operation of the circuit breaker, wherein the particle trap has an inner surface facing the central longitudinal axis and being arranged at a second distance from the central longitudinal axis, the second distance being larger than the first distance.

Accordingly, the particle trap is located at a position being radially outwards in relation to the insulator. Due to this outer position, particles can be securely trapped in the particle trap so that the particles are prevented from leaving the particle trap during internal movement or vibrations in the circuit breaker.

The circuit breaker may comprise at least one insulator flange for coupling the insulator to further parts of the circuit breaker. As an example, the insulator flange may establish a coupling to contact supports of the circuit breaker. The contact supports support the first and/or second main contact of the circuit breaker. The particle trap may be formed by the insulator flange. The insulator flange may be located at an outer surface of the insulator, wherein the outer surface faces away from the central longitudinal axis.

Accordingly, the insulator flange may have a double function of coupling the insulator to the contact supports and collecting particles generated during operation. The insulator flange may comprise a coupling portion for coupling to the contact supports. The particle trap may be separate from the coupling portion. Accordingly, the particle trap itself has not a double function of collecting particles and coupling.

The particle trap may comprise an entrance through which particles can enter the particle trap, wherein the entrance is located at an axial end of the insulator. The particle trap may be closed to the outside of the circuit breaker such that the particles cannot leave the particle trap towards the outside. The particle trap may be accessible only through the entrance.

The particle trap may comprises a pocket, the pocket being located behind the insulator when seen radially outwards from the central longitudinal axis. In this case, particles cannot easily move from the pocket back towards an inner surface of the insulator.

The pocket may be shielded from an electric field by a metal shield being located between the pocket and the insulator. Thereby, the particles are prevented from being drawn out of the particle trap by an electric field. The metal shield may be formed by the insulator flange.

The particle trap may be located at a lowermost portion of the insulator flange, wherein the lowermost portion is lowermost in regard of gravity in an installation position of the circuit breaker. Thereby, the particles can enter the particle trap due to gravity and are prevented by gravity from leaving the particle trap.

The circuit breaker may comprise at least two particle traps located at opposite axial ends of the insulator. Each of the particle trap may be formed by a flange and may have any functional and structural characteristics as described in the forgoing.

### BRIEF DESCRIPTION OF THE DRAWINGS

Further features, refinements and expediencies become apparent from the following description of the exemplary embodiments in connection with the figures. In the figures, elements of the same structure and/or functionality may be referenced by the same reference signs. It is to be understood that the embodiments shown in the figures are illustrative representations and are not necessarily drawn to scale.

FIG. 1 shows an embodiment of a high-voltage circuit breaker with a particle trap in a cross-sectional view.

FIG. 2 shows an embodiment of a particle trap in a perspective view.

### DETAILED DESCRIPTION

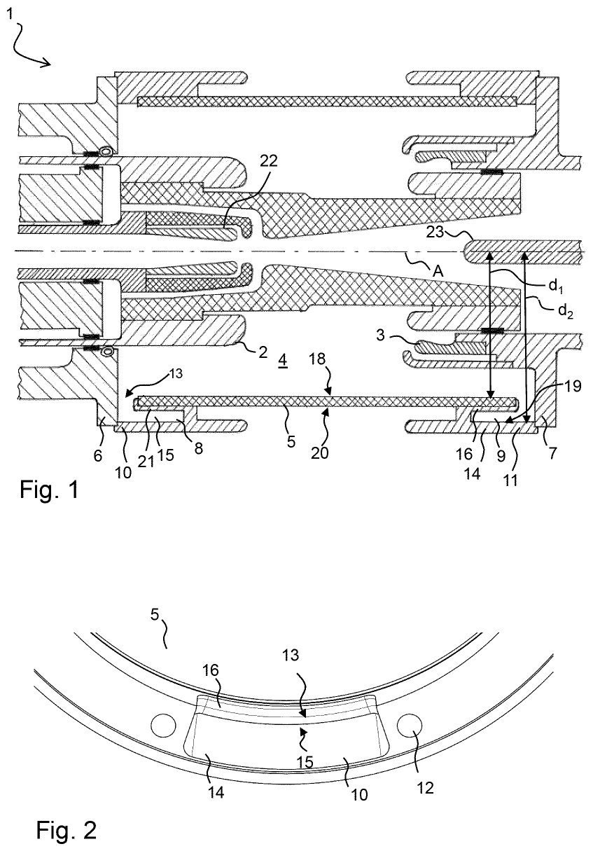

FIG. 1 shows a high-voltage circuit breaker 1 in a cross-sectional view. The circuit breaker 1 may be part of a gas-insulated switchgear.

The circuit breaker 1 comprises a first main contact 2 and a second main contact 3. The first main contact 2 and the second main contact 3 can be moved from a closed state, in which the main contacts 2, 3 are electrically contacted to each other, to an open state in which the electrical connection is broken. The first main contact 2 may be a movable contact and the second main contact 3 may be a fixed contact, for example. The circuit breaker 1 further comprises a first arc contact 22 and a second arc contact 23 for extinguishing electric arcs that may form between the main contacts 2, 3 during separation of the main contacts 2, 3. In FIG. 1, the open state of the circuit breaker 1 is depicted.

The main contacts 2, 3 extend about a central longitudinal axis A. For closing and opening the main contacts 2, 3, the main contacts 2, 3 are moved towards each other or moved in opposite directions along the central longitudinal axis A.

The main contacts 2, 3 are at least partially enclosed by an insulator 5, both in the open state and in the closed state. The insulator 5 has a tubular shape. The insulator 5 may be permanently fixed to contact supports 6, 7 of the first main contact 2 and the second main contact 3 by flanges 10, 11. The first main contact 2 may be axially movable relative to the contact supports 6, 7 and the second main contact 3 may be fixed relative to the contact supports 6, 7. The first contact support 6 is a support for the first main contact 2 and the second contact support 7 is a support for the second main contact 3. The contact supports 6, 7 may be current carrying parts.

The insulator 5 has an inner surface 18 facing the central longitudinal axis A and being arranged at a first distance d₁ from the central longitudinal axis A.

During mechanical switching and power shots, conductive particles may be generated, e.g. due to friction at the main contacts 2, 3. The particles and also dust may accumulate in a gas-filled insulation gap 4 and on surfaces inside the circuit breaker 1. The particles or dust may vary in size, conductivity and material, for example. The particles may lead to a flash-over, depending on the amount, the sizes and the location of the particles. As an example, the particles may accumulate on surfaces of the insulator 5 and may lead to a deterioration of the insulating function.

To avoid an accumulation of particles at locations leading to flash-overs, particle traps 8, 9 are provided at the insulator 5. The particle traps 8, 9 are configured to collect and trap particles such that the insulator 5 and the entire circuit breaker 1 is kept clean from particles, especially in the vicinity of the insulation gaps 4.

The particle traps 8, 9 are integrated in the insulator flanges 10, 11 which are located at opposite ends of the insulator 5. The insulator flanges 10, 11 are configured to fix the insulator 5 to the contact supports 6, 7. The insulator flanges 10, 11 enclose the insulator 5 at both axial ends of the insulator 5. The insulator flanges 10, 11 directly adjoin an outer surface of the insulator 5, wherein the outer surface is directed away from the central longitudinal axis A. The insulator flanges 10, 11 also adjoin axial end faces of the insulator 5.

In the following, the structure of the insulator flanges 10, 11 and particle traps 8, 9 is described in further detail with reference to one insulator flange 10 and one particle trap 8. However, the structure can be the same for the other insulator flange 11 and particle trap 9.

The particle trap 8 has an inner surface 19 facing the central longitudinal axis A, the inner surface 19 being arranged at a second distance d₂ from the central longitudinal axis A. The second distance d₂ is larger than the first distance d₁.

The particle trap 8 is accessible for particles coming from the insulation gap 4 via an entrance 13. The entrance 13 is located beyond an axial end of the insulator 5. The entrance 13 is delimited in a direction radially outwards by an outer wall 14 of the flange 10. In an axial direction away from the insulator 5, the entrance 13 is delimited by the contact support 6 and in an axial direction towards the insulator 5, the entrance 13 is delimited by the insulator 5.

The particle trap 8 further comprises a pocket 15 which is formed by an undercut in the flange 11. The pocket 15 is located beyond the insulator 5 when seen from the central longitudinal axis A.

The insulator 5 may be formed by an insulating material such as insulating papers. The insulator flange 10, 11 may be formed by a metal. As an example, the insulator flanges 10, 11 may comprise or consist of aluminum. Thereby, a metal shield 19 is provided which electrically shield the particle trap 8. It is also possible that the metal shield 19 is formed by a separate component. In particular, the particle trap 8 is at least partially shielded from an electric field inside the circuit breaker 1, whereby the particles are prevented from being drawn out of the particle trap 8 by the electric field.

FIG. 2 shows a detail of the insulator 5 and the insulator flange 10 with an integrated particle trap 8. The entrance 13 is formed by a recess in an inner wall 16 of the insulator flange 10. Accordingly, the inner wall 16 is recessed in an axial direction relative to the outer wall 14.

As can be seen in FIG. 2, the insulator flange 10 comprises a coupling portion 12 for coupling the insulator 5 to a contact support 6. The coupling portion 12 may comprise a receiving hole for a bolt connection, for example.

The particle trap 8 may be located only at a limited radial section of the circumferential flange 10 as depicted in FIG. 2, or may be arranged circumferentially along the entire flange 10. It is also possible that each of the flanges 10, 11 comprises several particle traps 8 located at different angular positions about the longitudinal axis A. The particle trap 8, 9 may be located at least at a lowermost portion of the flange 10, 11, i.e., a portion which is lowermost in regard of gravity in an installation position of the circuit breaker 1.

Particles generated at the main contacts 2, 3 or elsewhere inside the circuit breaker 1 may fall on the insulator 5. Due to mechanical movement, vibrations or gas flow, the particles are pushed on the sides of the insulator 5 and enter the pocket 15 through the entrance 13 due to gravity. Due to mechanical movement and vibrations, the particles at least partially enter the pocket 15 where they can safely accumulate. It is also possible that the pocket 15 has a depression relative to adjacent parts of the flange 10 which may further prevent particles from leaving the pocket 15.

Overall, the particle trap 8 reliably traps the particles such that the insulation is not deteriorated and the performance of the circuit breaker 1 is improved.

### REFERENCE SIGNS

1 high-voltage circuit breaker
2 first main contact
3 second main contact
4 insulation gap
5 insulator
6 contact support
7 contact support
8 particle trap
9 particle trap
10 insulator flange
11 insulator flange
12 coupling portion
13 entrance
14 outer wall
15 pocket
16 inner wall
18 inner surface of insulator
19 inner surface of particle trap
20 outer surface of insulator
21 metal shield
22 first arc contact
23 second arc contact
d₁ distance of inner surface of insulator to central longitudinal axis
d₂ distance of inner surface of particle trap to central longitudinal axis

1. A high-voltage circuit breaker, comprising:
a first main contact and a second main contact extending along a central longitudinal axis and being at least partially enclosed by an insulator, the insulator having an inner surface facing the central longitudinal axis and being arranged at a first distance from the central longitudinal axis; and
at least one particle trap for trapping particles generated during operation of the circuit breaker, the particle trap having an inner surface facing the central longitudinal axis and being arranged at a second distance from the central longitudinal axis, the second distance being larger than the first distance.

2. The high-voltage circuit breaker of claim 1, further comprising at least one insulator flange for coupling the insulator to further parts of the circuit breaker, wherein the particle trap is formed by the insulator flange.

3. The high-voltage circuit breaker of claim 2, wherein the insulator flange is located at an outer surface of the insulator, the outer surface facing away from the central longitudinal axis.

4. The high-voltage circuit breaker of claim 1, wherein the particle trap comprises a pocket, the pocket being located behind the insulator when seen radially outwards from the central longitudinal axis.

5. The high-voltage circuit breaker of claim 4, wherein the pocket is shielded from an electric field by a metal shield being located at an outer surface of the insulator.

6. The high-voltage circuit breaker of claim 5, wherein the metal shield is formed by an insulator flange.

7. The high-voltage circuit breaker of claim 1, wherein the particle trap comprises an entrance through which particles can enter the particle trap, wherein the entrance is located at an axial end of the insulator.

8. The high-voltage circuit breaker of claim 1, wherein the particle trap is confined in a radial direction by an inner wall and by an outer wall of the insulator flange, wherein the inner wall is recessed along the central longitudinal axis relative to the outer wall.

9. The high-voltage circuit breaker of claim 1, wherein the particle trap has not an additional coupling function of coupling the flange to another part.

10. The high-voltage circuit breaker of claim 1, comprising at least two particle traps located at opposite axial ends of the insulator.

11. The high-voltage circuit breaker of claim 1, wherein the particle trap is located at a lowermost portion of the insulator flange, wherein the lowermost portion is lowermost in regard of gravity in an installation position of the circuit breaker.

12. A gas-insulated switchgear comprising:
a high-voltage circuit breaker, comprising:
a first main contact and a second main contact extending along a central longitudinal axis and being at least partially enclosed by an insulator, the insulator having an inner surface facing the central longitudinal axis and being arranged at a first distance from the central longitudinal axis; and
at least one particle trap for trapping particles generated during operation of the circuit breaker, the particle trap having an inner surface facing the central longitudinal axis and being arranged at a second distance from the central longitudinal axis, the second distance being larger than the first distance.

13. The gas-insulated switchgear of claim 12, the circuit breaker further comprising at least one insulator flange for coupling the insulator to further parts of the circuit breaker, wherein the particle trap is formed by the insulator flange.

14. The gas-insulated switchgear of claim 13, wherein the insulator flange is located at an outer surface of the insulator, the outer surface facing away from the central longitudinal axis.

15. The gas-insulated switchgear of claim 12, wherein the particle trap comprises a pocket, the pocket being located behind the insulator when seen radially outwards from the central longitudinal axis.

16. The gas-insulated switchgear of claim 15, wherein the pocket is shielded from an electric field by a metal shield being located at an outer surface of the insulator.

17. The gas-insulated switchgear of claim 16, wherein the metal shield is formed by an insulator flange.

18. The gas-insulated switchgear of claim 12, wherein the particle trap comprises an entrance through which particles can enter the particle trap, wherein the entrance is located at an axial end of the insulator.

19. The gas-insulated switchgear of claim 12, wherein the particle trap is confined in a radial direction by an inner wall and by an outer wall of the insulator flange, wherein the inner wall is recessed along the central longitudinal axis relative to the outer wall.

20. The gas-insulated switchgear of claim 12, wherein the particle trap has not an additional coupling function of coupling the flange to another part.
